(19) United States
(12) Patent Application Publication
(10) Pub. No.: US 2007/0226099 A1
(43) Pub. Date: Sep. 27, 2007

(54) SYSTEM AND METHOD FOR PREDICTING THE FINANCIAL HEALTH OF A BUSINESS ENTITY

(75) Inventors: Deniz Senturk-Doganaksoy, Danbury, CT (US); Christina Ann LaComb, Schenectady, NY (US); Marat Doganaksoy, Danbury, CT (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/744,472

(22) Filed: May 4, 2007

Related U.S. Application Data
(63) Continuation-in-part of application No. 11/301,669, filed on Dec. 13, 2005.

(51) Int. Cl. G06Q 40/00

(52) U.S. Cl. 705/35

(57) ABSTRACT

A method for predicting the financial health of a business entity is provided. The method comprises generating one or more anomaly scores and one or more multi-dimensional time-varying patterns for one or more financial metrics related to a business entity and analyzing the one or more anomaly scores and the one or more multi-dimensional time-varying patterns for the one or more financial metrics, using a dynamic predictive modeling system. The method then comprises predicting one or more business behavioral patterns related to the business entity based on the step of analyzing and aggregating the one or more predicted business behavioral patterns in a selected manner to predict the financial health of the business entity.

### CROSS REFERENCE TO RELATED APPLICATIONS

This application is a continuation in part of U.S. patent application Ser. No. 11/301,669, entitled “Statistical Pattern Recognition and Analysis”, filed 13 Dec. 2005, which is herein incorporated by reference.

### BACKGROUND

The invention relates generally to the analysis of financial data associated with a business entity and more particularly to a system and method for predicting the financial health of a business entity.

Understanding the financial health of a business entity or a company is an important factor in evaluating a potential business interaction with that company or business entity. An understanding of a company's financial health can be used to help evaluate the risks involved in doing business with that company, and can form a basis for predicting the expected benefits from the potential business relationship or transaction. The financial health of a company may be monitored using one or more commercially available tools known in the art, such as, for example, credit scores and financial prediction models. These tools typically utilize publicly available sources of financial information and predict the financial health of a company by analyzing a few critical company specific financial ratios and metrics (such as for example, the Altman's z-score) over a specific period of time.

The above tools, while being effective in predicting the financial health of a company or a business entity, generally produce good prediction results for companies or business entities whose financial ratios and metrics exhibit a relatively stable behavioral pattern over a period of time. Moreover, the predictive power of these tools is affected by a number of factors such as the size of the company or business entity, the type of industry in which the business entity operates, the type of operation of the business entity over time and changes in the overall economic environment in which the business entity operates. Since the predictive power of these tools tends to vary across different companies and/or different industries, a number of individual prediction models representing different data segments (such as for example, different industries and/or economic environments) have to be created to obtain good prediction results. Furthermore, the predictions from these tools tend to be unsatisfactory for mid-size companies, small companies and private companies, and prove to be very unstable across different (good or bad) economic environments. In addition, these tools are generally not capable of calibrating their predictive power across these different data segments automatically, and hence require frequent manual maintenance to produce valid prediction results.

It would be desirable to develop a dynamic prediction modeling system that takes into consideration, time varying financial data across multiple dimensions in the prediction of the financial health of a company or a business entity. In addition, it would be desirable to develop a dynamic prediction modeling system that produces accurate and stable predictions across multiple periods of time, and across different industries and/or economic environments.

### BRIEF DESCRIPTION

In one embodiment, a method for predicting the financial health of a business entity is provided. The method comprises generating one or more anomaly scores and one or more multi-dimensional time-varying patterns for one or more financial metrics related to a business entity and analyzing the one or more anomaly scores and the one or more multi-dimensional time-varying patterns for the one or more financial metrics, using a dynamic predictive modeling system. The method further comprises predicting one or more business behavioral patterns related to the business entity based on the step of analyzing and aggregating the one or more predicted business behavioral patterns in a selected manner to predict the financial health of the business entity.

In another embodiment, a system for predicting the financial health of a business entity is provided. The system comprises a processor configured to generate one or more anomaly scores and one or more multi-dimensional time-varying patterns for one or more financial metrics related to the business entity. The processor further comprises a dynamic prediction modeling system configured to predict the financial health of the business entity. The dynamic prediction modeling system is configured to analyze the one or more anomaly scores and the one or more multi-dimensional time-varying patterns for the one or more financial metrics and predict one or more business behavioral patterns related to the business entity based on the analysis. The dynamic prediction modeling system is further configured to aggregate the one or more predicted business behavioral patterns in a selected manner to predict the financial health of the business entity.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic diagram of a system for predicting the financial health of a business entity in accordance with one embodiment of the invention;

FIG. 2 is a schematic diagram of an embodiment of a dynamic prediction modeling system used in the system shown in FIG. 1, for predicting the financial health of a business entity, in accordance with one embodiment of the present invention; and

FIG. 3 is a flow diagram of general process steps for predicting the financial health of a business entity, in accordance with one embodiment of the invention.

### DETAILED DESCRIPTION

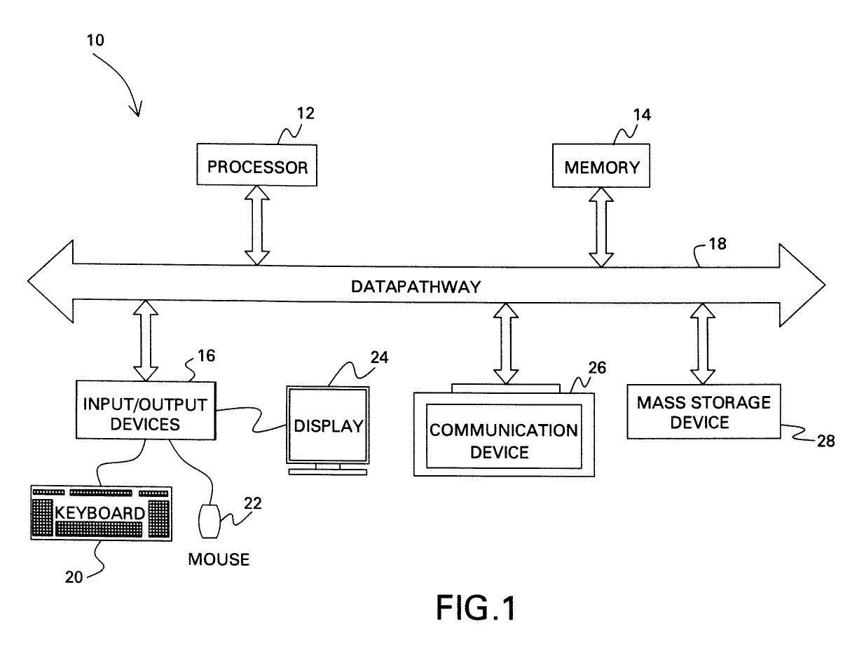

FIG. 1 is a schematic diagram of an embodiment of the system of the invention for predicting the financial health of a business entity. As shown in FIG. 1, the computer system 10 generally comprises a processor 12, a memory 14, and input/output devices 16 connected via a data pathway (e.g., buses) 18.

The processor 12 accepts instructions and data from the memory 14 and performs various data processing functions of the system, such as, for example, extracting financial information related to a business entity from different information sources, and performing analytics on the extracted data. The processor 12 comprises an arithmetic logic unit (ALU) that performs arithmetic and logical operations, and a control unit that extracts instructions from memory 14 and decodes and executes them, calling on the ALU when necessary. The memory 14 stores a variety of data computed by the various data processing functions of the system 10. The data may include, for example, quantitative and qualitative financial data, financial measures and ratios, financial rating scores, and financial metrics associated with a business entity. The memory 14 generally includes a random-access memory (RAM) and a read-only memory (ROM); however, there may be other types of memory such as programmable read-only memory (PROM), erasable programmable read-only memory (EPROM) and electrically erasable programmable read-only memory (EEPROM). Also, the memory 14 preferably contains an operating system, which executes on the processor 12. The operating system performs basic tasks that include recognizing input, sending output to output devices, keeping track of files and directories and controlling various peripheral devices. The information in the memory 14 might be conveyed to a human user through the input/output devices 16, the data pathway 18, or in some other suitable manner.

The input/output devices 16 may further include a keyboard 20 and a mouse 22 that a user can use to enter data and instructions into the computer system 10. Additionally, a display 24 may be used to allow a user to see what the computer has accomplished. Other output devices may include a printer, plotter, synthesizer and speakers. The computer system 10 may further include a communication device 26 such as a telephone, cable or wireless modem or a network card such as an Ethernet adapter, local area network (LAN) adapter, integrated services digital network (ISDN) adapter, or Digital Subscriber Line (DSL) adapter, that enables the computer system 10 to access other computers and resources on a network such as a LAN or a wide area network (WAN). The computer system 10 may also comprise a mass storage device 28 to allow the computer system 10 to retain large amounts of data permanently. The mass storage device may comprise all types of memory storage devices such as floppy disks, hard disks and optical disks, as well as tape drives that can read and write data onto a tape that could include digital audio tapes (DAT), digital linear tapes (DLT), or other magnetically coded media.

The above-described computer system 10 may take the form of a hand-held digital computer, personal digital assistant computer, notebook computer, personal computer, workstation, mini-computer, mainframe computer or supercomputer. In particular, control logic and/or automated routines for performing the techniques and steps described herein may be implemented by the computer system 10, either by hardware, software, or combinations of hardware and software. For example, suitable code may be accessed and executed by the processor 12 to perform some or all of the techniques described herein. Similarly application specific integrated circuits (ASICs) configured to perform some or all of the techniques described herein may be included in the processor 12.

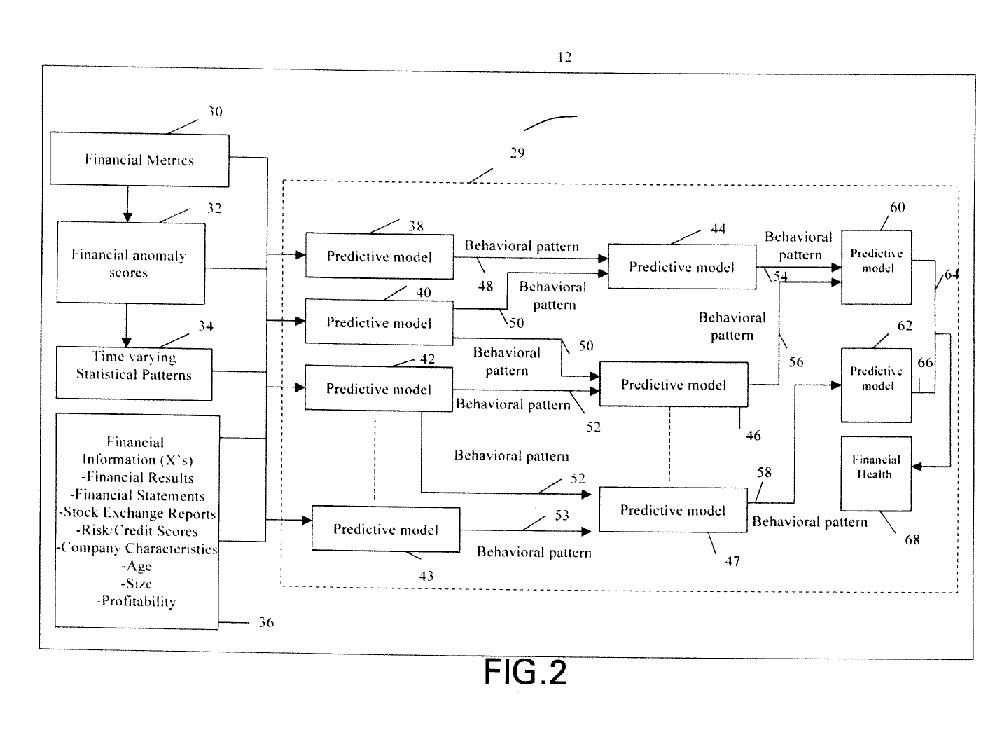

FIG. 2 is a schematic diagram of an embodiment of a dynamic prediction modeling system used in the system shown in FIG. 1, for predicting the financial health of a business entity, in accordance with one embodiment of the present invention. In a particular embodiment, and as will be described in greater detail below, the dynamic prediction modeling system 29 shown in FIG. 2 is configured to predict the financial health 68 of the business entity based upon financial data associated with the business entity. The financial data may include, for example, financial metrics 30, financial anomaly scores 32, multi-dimensional time varying patterns 34 and financial information 36. Specifically, the dynamic prediction modeling system 29 may be configured to use the financial data as input parameters into one or more predictive models to predict one or more business behavioral patterns, indicative of the financial health of the business entity. As used herein, business behavioral patterns may include, but are not limited to financial decline, likelihood of fraud, financial credit or investment risk and/or good credit or investment prospects associated with the business entity. Also, as used herein, a financial metric 30 may refer to any piece of financial data that is associated with the performance or operation of a company or business entity over a particular period of time. For instance, a classic financial metric is net income. Other financial metrics include, but are not limited to: total revenue; inventory on hand; capital expenses; interest payments; debt; and earnings before interest, taxes, depreciation and amortization (EBITDA). Financial information 36 may include, for example, financial results and internal financial statements related to the business entity, stock exchange reports, quantitative risk scores related to the business entity, and one or more data characteristics associated with the business entity, such as for example, the age, size and profitability of the business entity.

In one embodiment, the processor 12 is configured to generate the anomaly scores 32 by statistically analyzing historical data related to the financial metrics 30 over a period of time. The generation of the anomaly scores 32 enables the identification of unhealthy or fraudulent financial data associated with a business entity. In a particular embodiment, the processor 12 is configured to identify a degree of deviation of a particular value associated with the financial metric with respect to the historical data associated with the financial metric, in order to evaluate whether or not a given financial metric is anomalous. Specifically, the processor 12 may use one or more statistical techniques, such as Z-scores, to evaluate the degree to which a particular value associated with the financial metric is an outlier, or in other words, anomalous. Details of the implementation and generation of anomaly scores and Z-scores for financial metrics is described in co-pending U.S. patent application Ser. No. 11/022,402 entitled “Method and System for Anomaly Detection in Small Datasets”, filed on 27 Dec. 2004, the entirety of which is hereby incorporated by reference herein.

The anomaly scores 32 may further be used by the processor 12 to generate one or more multi-dimensional time-varying patterns 34. As used herein, a multi-dimensional time-varying pattern refers to a statistical pattern of interest derived for a business entity across multiple time periods and/or across multiple dimensions. The statistical patterns of interest may be representative of declining financial health and/or warning signs for misleading financials, associated with the business entity. A statistical pattern of interest may include for example, a time-varying pattern across one dimension (e.g., net income, leverage, or ratio of slopes for cash flow from operations and net income) and across a desired number of consecutive time periods (e.g., quarters). In another example, a statistical pattern of interest may include a dimension-varying pattern, such as all the earning measures (e.g., raw financials or modified Z-scores), at a specific time period (i.e., specific year and quarter), which may be aggregated via central tendency (i.e., mean, median, mode) or variance (i.e., standard deviation, variance, quartiles, range) or Z-score (i.e., traditional Z-scores or modified Z-scores) measures. Details of the implementation and generation of multi- dimensional time-varying patterns are described in co-pending U.S. patent application Ser. No. 11/301,669 entitled “Statistical Pattern Recognition and Analysis”, filed on 13 Dec. 2005, the entirety of which is hereby incorporated by reference herein.

Referring to FIG. 2, the dynamic prediction modeling system 29 may include one or more predictive models (represented generally by the reference numerals 38, 40, 42, 43, 44, 46, 47, 60 and 62) configured to predict the financial health of the business entity. The predictive models may utilize a plurality of predictive modeling techniques to predict the financial health of the business entity. The predictive modeling techniques may include, but are not limited to, decision trees, logistic regression classification, survival analysis, outlier detection, trend analysis, correlation analysis and factor and cluster analysis. A decision tree is a predictive modeling technique that predicts outcomes in a dataset based on searching and discovering trends, patterns and relationships in the dataset. A decision tree is generally represented as a graph of decisions, where the nodes of the graph represent one or more data classifications and the edges of the graph represent conjunctions of features that lead to those classifications. Decision trees may be implemented using decision tool software, such as, for example, CARTS (Classification and Regression Trees), to search and isolate significant patterns and relationships in datasets. Similarly, logistic regression classifiers refer to predictive modeling techniques that perform predictions by analyzing relationships between one or more parameters of interest (dependent variables/response variables) and a set of predictor variables (independent variables). Survival analysis is a branch of statistics that involves the modeling of time to event data. A prediction modeling technique based on survival analysis generally includes the use of a survival function to represent the probability of the occurrence of an event at a future point in time. Outlier detection statistically measures whether a financial measure associated with a business entity is significantly “high” or “low.” Trend analysis measures statistical significance in rates of change, by identifying significantly “high” or “low” increases or decreases. Correlation analysis and regression analysis are used to identify relationships between quantitative metrics associated with the business entity. Factor and cluster analyses are used to classify financial measures and observations, respectively.

Referring to FIG. 2 again, the dynamic prediction modeling system 29 may further be configured to analyze one or more of the predicted business behavioral patterns across multiple time periods. In one embodiment, the dynamic prediction modeling system 29 may utilize a network of predictive models to analyze the behavioral patterns and predict the financial health of the business entity. For example, the dynamic prediction modeling system 29 may be configured to initially generate one or more of the behavioral patterns, such as, for example, 48, 50 by analyzing one or more financial anomaly scores 32 and one or more time-varying statistical patterns 34 using one or more of the predictive models, such as for example, 38 and 40. In one embodiment, the predictive model 38 may be configured to use a predictive modeling technique based on decision trees to predict the behavioral pattern 48, wherein the decision trees may further be used to classify good and/or poor statistical patterns exhibited by the business entity, in terms of financial default. The hit rates determined from these patterns may also be used as a basis for the classification of good vs. poor statistical patterns exhibited by the business entity over a period of time, by determining the number of times the business entity was classified with a good or a poor financial pattern over a specific period of time. Similarly, the predictive model 40 may be configured to use a predictive modeling technique based on logistic regression classifiers (that are specifically tailored to achieve a desired performance objective), to predict the behavioral pattern 50 associated with the business entity. Specifically, the logistic regression classifier may be used to capture behavioral patterns that represent “definite non-default” companies/business entities over a period of time (for example, such as over a period of two years) and the desired performance objective from the logistic regression classifier may be to have close to zero false positives. In another example, the logistic regression classifier may be used to capture behavioral patterns that represent companies/business entities that will default in one year and the desired performance objective may be to obtain a high hit rate of default companies at the expense of increasing the false positive rate.

The predicted behavioral patterns 48 and 50 may further be analyzed using one or more additional predictive models 44 and 46 and these analyzed patterns may further be aggregated in a selected manner, to predict the financial health 68 of the business entity. In a particular example, aggregated behavioral patterns 54 and 56 may be generated by further analyzing the predicted behavioral patterns 48, 50 and 52 using one or more additional predictive models 44 and 46 that implement one or more predictive modeling techniques. For example, the behavioral patterns 48 and 50 may further be used as input parameters into one or more additional predictive models 44 and 46 to generate one or more aggregated business behavioral patterns 54 and 56. Further, the results/behavioral patterns from the various predictive models may be aggregated in an orthogonal way. In one example, the behavioral patterns from a predicted model that uses decision trees may be used as an input in predictive models that use logistic classifiers and survival analysis to further analyze the behavioral patterns. In another example, a predictive model that uses a logistic regression classifier to predict a behavioral pattern that represents “non-default companies” over a period of two years may be aggregated with another predictive model that uses a logistic regression classifier to predict a behavioral pattern that represents “default companies” over a period of one year, to represent a set of companies/business entities that will default over the one year period. In another example, a behavioral pattern indicative of a business entity not defaulting over a period of eight quarters may be combined with a behavioral pattern indicative of the business entity defaulting over a period four quarters to determine the overall financial health of the business entity, wherein the financial health of the business entity is indicative of a behavioral pattern exhibited by the business entity over a period of six months to two years. In yet another example, predictive models with similar behavioral patterns may be aggregated across predictive modeling techniques and/or across time to determine a more accurate behavioral pattern, indicative of the financial health of the business entity. For example, one or more behavioral patterns indicative of credit scores may be derived using two different predictive modeling techniques and these patterns may be combined to determine an aggregated behavioral pattern indicative of the overall credit risk associated with the business entity. The particular examples described above are for illustrative purposes only, and are not meant to limit other types of examples and/or combinations of predictive modeling techniques that may be utilized by the dynamic prediction modeling system 29 in the prediction of the financial health of the business entity.

The utilization of multiple results/patterns from multiple intermediary predictive models as inputs into subsequent predictive models enables a more accurate representation of the varied aspects of the overall risk associated with the business entity. In particular, and as described above, the effectiveness and/or advantage of each predictive modeling technique may be maximized by using various combinations of predictive modeling techniques in a network of predictive models, to determine an accurate prediction of the financial health of the business entity. For example, decision trees may be used to classify data with missing values (such as, for example, missing values in company classification), and valuable time predictions may be retained by using logistic classifiers with the desired performance objective and survival analysis techniques may be used for censored data. Similarly, predictive modeling techniques based on logistic regression classifiers and survival analysis may be combined to predict a particular time period in which a business entity will default, if at all.

In addition, one or more of the embodiments of the dynamic prediction modeling system 29 may be configured to use a combination of financial anomaly scores and time varying multi-dimensional patterns as inputs into the predictive models to capture multiple aspects of risk leading to financial default. For example, the utilization of anomaly scores in combination with time varying patterns as inputs into the predictive models enables the creation of a single model that may be used to provide accurate predictions across different data segments, such as for example, across different industries (mid-size vs. large companies, young vs. mature companies) and/or economic environments. The time-varying aspect of the inputs to the predictive models maintains the high predictive power of the dynamic prediction modeling system across multiple time periods with minimal or no requirements needed for future calibrations and/or validations.

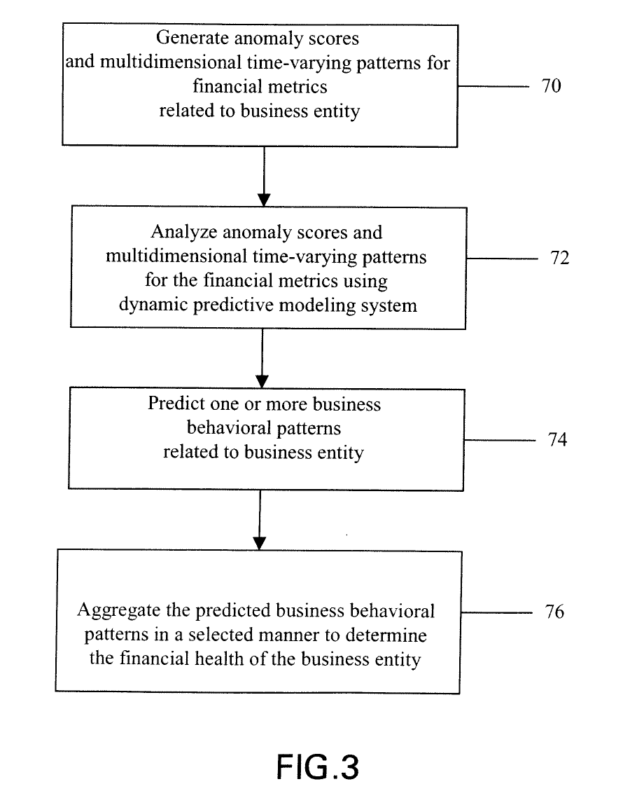

FIG. 3 is a flow diagram of general process steps for predicting the financial health of a business entity, in accordance with one embodiment of the invention. In step 70, one or more anomaly scores 32 and one or more multi-dimensional time-varying patterns 34 are generated for one or more financial metrics 30 related to a business entity. As described above, the anomaly scores 32 may be generated by statistically analyzing historical data related to the financial metrics over a period of time and the multi-dimensional time-varying patterns 34 may be generated by determining one or more statistical patterns of interest for the financial metrics across multiple time periods. In step 72, the anomaly scores 32 and the multi-dimensional time-varying patterns 34 are analyzed using a dynamic prediction modeling system. In step 74, one or more behavioral patterns are predicted based on the step of analyzing. In step 76, the predicted behavioral patterns are aggregated in a selected manner to predict the financial health of the business entity. As described above, the dynamic prediction modeling system 29 may comprise one or more predictive models configured to predict the behavioral patters related to the business entity. The dynamic prediction modeling system may further be configured to analyze the predicted behavioral patterns using one or more of the predicted models and aggregate the analyzed behavioral patterns using one or more of the predicted models to determine the financial health of the business entity.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for predicting the financial health of a business entity, comprising the steps of:
generating one or more anomaly scores and one or more multi-dimensional time-varying patterns for one or more financial metrics related to a business entity;
analyzing the one or more anomaly scores and the one or more multi- dimensional time-varying patterns for the one or more financial metrics, using a dynamic predictive modeling system;
predicting one or more business behavioral patterns related to the business entity based on the step of analyzing; and
aggregating the one or more predicted business behavioral patterns to predict the financial health of the business entity.

2. The method of claim 1, wherein the one or more financial metrics are selected from a group consisting of the business' net income, cash flow from operations, revenue, inventory on hand, capital expenses, interest payments, debt, and EBITDA.

3. The method of claim 1, wherein the step of generating the one or more anomaly scores comprises statistically analyzing one or more historical data for one or more of the financial metrics over a period of time.

4. The method of claim 3, further comprising the step of identifying a degree of deviation of one or more of the financial metrics from one or more of the historical data for one or more of the financial metrics.

5. The method of claim 1, wherein the step of generating the one or more multi-dimensional time-varying patterns comprises determining one or more statistical patterns of interest for one or more of the financial metrics for a plurality of time periods.

6. The method of claim 1, further comprising the step of using financial information for the business entity to predict the one or more business behavioral patterns.

7. The method of claim 6, wherein the financial information is selected from the group consisting of financial results, internal financial statements, stock exchange reports and quantitative risk scores.

8. The method of claim 1, wherein the dynamic predictive modeling system comprises one or more predictive models configured to predict the one or more business behavioral patterns related to the business entity.

9. The method of claim 8, further comprising the step of analyzing the one or more predicted business behavioral patterns over multiple time periods using one or more of the predictive models.

10. The method of claim 9, further comprising the step of aggregating one or more of the analyzed business behavioral patterns using one or more of the predicted models, to determine the financial health of the business entity.

11. The method of claim 8, wherein the one or more predictive models utilize a plurality of predictive modeling techniques to predict the financial health of the business entity.

12. The method of claim 11, wherein the predictive modeling techniques are selected from a group consisting of decision trees, logistic regression classification, survival analysis, outlier detection, trend analysis, correlation analysis and factor and cluster analysis.

13. The method of claim 1, wherein the business behavioral patterns comprise at least one of financial decline, likelihood of fraud, financial credit or investment risk and good credit or investment prospect associated with the business entity.

14. A system for predicting the financial health of a business entity, comprising:
a processor configured to generate one or more anomaly scores and one or more multi-dimensional time-varying patterns for one or more financial metrics related to the business entity,
wherein the processor comprises a dynamic prediction modeling system configured to predict the financial health of the business entity.

15. The system of claim 14, wherein the dynamic prediction modeling system is configured to:
analyze the one or more anomaly scores and the one or more multi- dimensional time-varying patterns for the one or more financial metrics;
predict one or more business behavioral patterns related to the business entity based on the analysis; and
aggregate the one or more predicted business behavioral patterns to predict the financial health of the business entity.

16. The system of claim 14, wherein the one or more financial metrics are selected from a group consisting of the business' net income, cash flow from operations, revenue, inventory on hand, capital expenses, interest payments, debt, and EBITDA.

17. The system of claim 14, wherein the processor is configured to generate the one or more anomaly scores at least in part by statistically analyzing one or more historical data for one or more of the financial metrics over a period of time.

18. The system of claim 17, wherein the processor is further configured to identify a degree of deviation of one or more of the financial metrics from one or more of the historical data for one or more of the financial metrics.

19. The system of claim 14, wherein the processor is configured to generate the one or more multi-dimensional time-varying patterns at least in part by determining one or more statistical patterns of interest for one or more of the financial metrics for a plurality of time periods.

20. The system of claim 15, wherein the dynamic prediction modeling system is further configured to use financial information for the business entity to predict the one or more business behavioral patterns.

21. The system of claim 20, wherein the financial information is selected from the group consisting of financial results, internal financial statements, stock exchange reports and quantitative risk scores.

22. The system of claim 15, wherein the dynamic predictive modeling system comprises one or more predictive models configured to predict the one or more business behavioral patterns related to the business entity.

23. The system of claim 22, wherein the dynamic predictive modeling system is further configured to analyze the one or more predicted business behavioral patterns over multiple time periods using one or more of the predictive models.

24. The system of claim 23, wherein the dynamic predictive modeling system is further configured to aggregate one or more of the analyzed business behavioral patterns using one or more of the predictive models to predict the financial health of the business entity.

25. The system of claim 22, wherein the one or more predictive models utilize a plurality of predictive modeling techniques to predict the financial health of the business entity.

26. The system of claim 25, wherein the predictive modeling techniques are selected from a group consisting of decision trees, logistic regression classification, survival analysis, outlier detection, trend analysis, correlation analysis and factor and cluster analysis.

27. The system of claim 14, wherein the business behavioral patterns comprise at least one of financial decline, likelihood of fraud, financial credit or investment risk and good credit or investment prospect associated with business entity.

28. A method for predicting the financial health of a business entity, comprising the steps of:
generating one or more anomaly scores and one or more multi-dimensional time-varying patterns for one or more financial metrics related to the business entity;
analyzing the one or more anomaly scores and the one or more multi- dimensional time-varying patterns for the one or more financial metrics using a dynamic predictive modeling system;
predicting one or more business behavioral patterns related to the business entity based on the step of analyzing; and
aggregating the one or more predicted business behavioral patterns to predict the financial health of the business entity.

29. A system that embodies the method of claim 28, comprising:
a processor configured to generate one or more anomaly scores and one or more multidimensional time-varying patterns for one or more financial metrics related to the business entity,
wherein the processor further comprises a dynamic prediction modeling system configured to predict the financial health of the business entity.

30. The system of claim 29, wherein the dynamic prediction modeling system is configured to:
analyze the one or more anomaly scores and the one or more multidimensional time-varying patterns for the one or more financial metrics;
predict one or more business behavioral patterns related to the business entity based on the analysis; and
aggregate the one or more business behavioral patterns in a selected manner to predict the financial health of the business entity.
